(19) United States
(12) Patent Application Publication
(10) Pub. No.: US 2016/0166925 A1
(43) Pub. Date: Jun. 16, 2016

(54) HYBRID GAME SYSTEM

(71) Applicant: FRIMA STUDIO INC., Québec (CA)

(72) Inventors: Simon Ampleman, Québec (CA); David St-Cyr, Québec (CA)

(21) Appl. No.: 14/903,535

(22) PCT Filed: Jul. 10, 2014
(86) PCT No.: PCT/CA2014/050657

§ 371 Date: Jan. 7, 2016

Related U.S. Application Data
(60) Provisional application No. 61/844,454, filed on Jul. 10, 2013.

(51) Int. Cl. A63F 13/24; A63F 13/211; A63F 9/24; A63F 13/214; A63F 13/54; A63F 13/285; A63F 13/31; A63F 13/235

(52) U.S. Cl. CPC A63F 13/24; A63F 13/31; A63F 13/211; A63F 13/235; A63F 13/214; A63F 13/54; A63F 13/285; A63F 9/24; A63F 2009/2408; A63F 2009/247; A63F 2009/2447; A63F 2009/2479; A63F 2009/2494

(57) ABSTRACT

The hybrid game system can include a virtual game software allowing virtual interaction of a plurality of characters with a virtual world in a manner leading to changes relating to said characters, the virtual game software being playable on a computer device operable to display the virtual interaction on a display screen; and a plurality of controllers, each controller having a communicator; an access to a memory adapted to store data concerning the changes relating to at least a character associated to the controller; a controller software allowing controller-to-controller interaction of the associated character directly with at least one character associated to another one of the controllers via direct communication between said controllers, the controller-to-controller interaction also leading to changes relating to said associated character.

### CROSS-REFERENCE TO RELATED APPLICATIONS

This application claims priority of U.S. provisional application 61/844,454, filed Jul. 10, 2013 by applicant, the contents of which are hereby incorporated by reference.

### FIELD

This specification relates to video game systems, and more specifically to a video game system and video game in which the controller used to control a character in a virtual world displayed on a distal display screen is also playable independently of the gaming console, directly with one or more other controllers.

### BACKGROUND

Video games are widely acclaimed, as the mere volume of sales of games in the industry demonstrates. It is known to play video games on computers, such as desktop computers and specialized computers (gaming consoles) such as Xbox™, Nintendo Wii™, Playstation™. In a video game, one or more users interacts with a virtual world via corresponding controllers each having a corresponding interface sensor system, often including a set of pushbuttons. Gaming software can be sold in the form of a disc, the contents of which is sometimes transferred to a hard drive, and other times directly accessed as a web-based applications. Many forms of gaming software involve a character evolving based upon his interactions with a virtual world, in accordance with a given set of game rules, or ‘conditions’.

Users shut down the computer or log out of the video game after having played the game for a given play period. In order to allow the users to resume the game at the same level of evolution at their return to the computer, it was known to record the evolution of the character in a memory. Nonetheless, users were dependent upon the computer receiving the game software for their game to evolve. There remained room for improvement.

### SUMMARY

A hybrid gaming system is provided in which users can play their game, and even evolve their character, not only using the virtual-world game software, but also independently of the virtual-interaction computer: by direct interaction between controllers. More specifically, the controllers allow users both to impart change pertaining to an associated character (such as character evolution) in a virtual world via a main computer software, and to continue to impart change to the associated character by playing an alternate game software stored in the controller computer and based on direct communication between two or more controllers. Henceforth, in one embodiment, the user can continue to evolve their characters directly with other users, outdoors.

In accordance with one aspect, there is provided a hybrid game system controller for use with a character memory containing character data being associated to a character, the hybrid game system controller comprising: a housing having a handle portion; a controller computer having a controller software for operating the controller and managing a controller-to-controller interaction mode of the hybrid game, the controller-to-control interaction mode allowing interaction of the associated character with at least one other character associated to an other controller; an interaction communication module operable to exchange data between the controller and both i) the at least one corresponding other controller during said controller-to-controller interaction; and ii) a virtual-interaction computer having a virtual game software managing a virtual interaction mode of the hybrid game, the virtual interaction mode allowing interaction of the associated character with a virtual world represented on a distal display screen; a sensor system operable manually by a user to control both the virtual interaction and the controller-to-controller interaction; and a battery port.

In accordance with another aspect, there is provided a method of playing a hybrid game using a controller, a character memory containing character data being associated to a character, and a virtual-interaction computer, the method comprising: a first user controlling the associated character in a controller-to-controller interaction mode using the controller wherein the associated character interacts with at least one character associated to a corresponding other controller controlled by an other, corresponding, user; and the first user controlling the associated character in a virtual interaction mode using the controller wherein the associated character interacts with a virtual world managed by the virtual interaction computer and represented on a distal display screen associated to the virtual interaction computer.

In accordance with another aspect, there is provided a hybrid game system comprising: a virtual game software allowing virtual interaction of a plurality of characters with a virtual world in a manner leading to changes relating to said characters, the virtual game software being playable on a computer device operable to display the virtual interaction on a display screen; a plurality of controllers, each controller having a communicator; an access to a memory adapted to store data concerning the changes relating to at least a character associated to the controller; a controller software allowing controller-to-controller interaction of the associated character directly with at least one character associated to another one of the controllers via direct communication between said controllers, the controller-to-controller interaction also leading to changes relating to said associated character; an interface sensor system allowing a user to control both the virtual interaction and the controller-to-controller interaction of the associated character via the communicator; an indicator system operable based on at least the controller-to-controller interaction.

In accordance with another aspect, there is provided a hybrid game system controller comprising: at least one port adapted to selectively receive the connector of a character item and thereby associate a corresponding one of a plurality of characters to the controller, the character item having a memory adapted to store data concerning an evolution of the associated character; a wireless communicator allowing virtual interaction of the associated character with a virtual world of a virtual game software represented on an external display screen, the virtual interaction leading to evolution of the associated character which is reflected on the memory; a controller software allowing controller-to-controller interaction of the associated character directly with at least one character associated to another controller via direct wireless communication between said controllers, the controller-to-controller interaction also leading to the evolution of said characters which is also reflected in the memory; an interface sensor system including at least an accelerometer sensor and allowing a user to control both the virtual interaction and the controller-to-controller interaction of the associated character via the wireless communicator; an indicator system operable based on at least the controller-to-controller interaction.

In accordance with another aspect, there is provided a computer-implemented game system, the computer-implemented game system comprising: a plurality of collectible items each having an item memory being computer readable and a connector, at least one of the collectible items being a character item associated to a specific game character, the item memory of the character item further being computer-writable; a main computer associated with a display screen, having a processor, and a wireless communicator operable by the processor, and being adapted to receive a game software including gaming data and virtual world data, wherein a character associated to the character item received in the controller can interact with a virtual world based on the virtual world data and the gaming data; a controller having a handle, a processor, a wireless communicator operable by the processor to detect and communicate with at least one other controller located within a communication distance, a port adapted to receive the connector of the character item and allowing the processor to read and write the item memory of a character item received in the port, a controller memory adapted to contain a first game software accessible by the processor, the game software including gaming data, evolution data and action data; an interface sensor allowing the processor to detect an action of a user of the controller and associate the detected action of a user to at least one action type defined in the action data; and an indicator, wherein the gaming data includes rules by which the specific game character associated to the received character item can interact with at least one game character associated to a detected other controller via the detected action types, and the evolution data includes rules by which the item memory of the received character item can be modified to reflect an evolution of the character based on the results of said interaction; and wherein the item memory of the received character item can be further modified to reflect an evolution of the character based on the interaction with the virtual world.

Many further features and combinations thereof concerning the present improvements will appear to those skilled in the art following a reading of the instant disclosure.

### DESCRIPTION OF THE FIGURES

In the figures,

FIG. 1 is bloc diagram of an example of a hybrid game system in virtual interaction mode;

FIG. 2 is a bloc diagram of an example of a hybrid game system controller in controller-to-controller interaction mode;

FIG. 3 is a bloc diagram of a hybrid game system controller showing detail;

FIGS. 4 to 6 show an example controller and character card taken from different angles.

### DETAILED DESCRIPTION

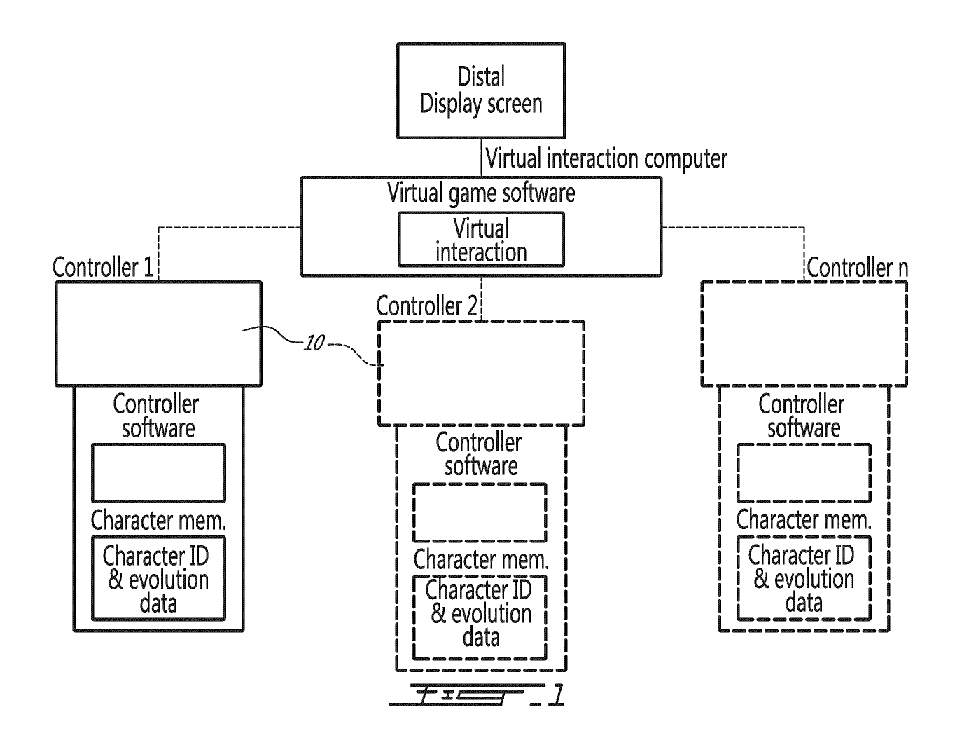

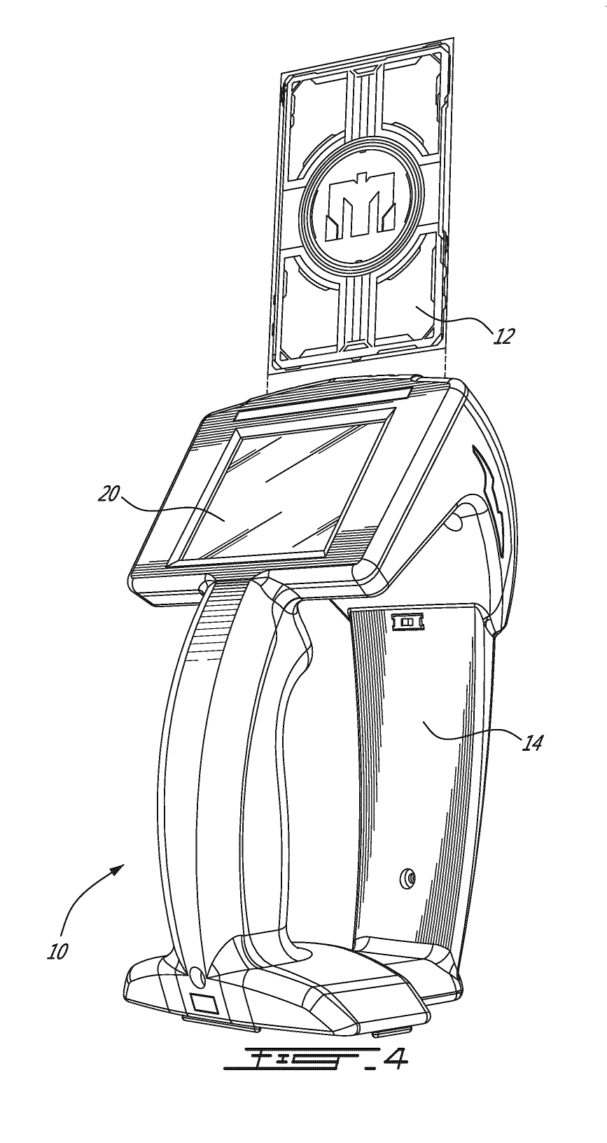

FIG. 1 shows an example of a hybrid game system in a virtual interaction mode where the hybrid game system can be seen to generally include a virtual game software which is playable on a computer referred here as the virtual-interaction computer, and a plurality of controllers 10 (shown in FIGS. 4 to 6), where each controller is associated to a player character. The virtual-interaction computer can be a desktop computer, video game console, etc. and the virtual-interaction software can be stored on an internal memory of the computer, or read by the computer on a CD, DVD, other data support, or even directly on the Web. The virtual game software includes data concerning a virtual world which can include adversaries, non-player characters, equipment or other items, and the like, for instance. The virtual game software also includes game data including a given set of rules by which the player character(s) can interact with the virtual world in a manner leading to evolution of the player character. The evolution of the character can be a change (increase or decrease) of stats such as strength, health, stamina, experience points, etc.; change or upgrade of equipment; obtaining items, special powers, etc. to name a few examples. The player character is controlled in the virtual world by the user via a corresponding controller, and more specifically by activation by the user of an interface sensor system which can include a plurality of push buttons, a joystick, an accelerometer or a plurality of accelerometers, or the like, for instance. The communication between the controller 10 and the software can be done in a wired manner, but wireless communication can be more practical. The actions of the player character in the virtual world can be observed by the user via the distal display screen.

The data concerning the evolution of the character stemming from its interactions with the virtual world is stored in a memory which will be referred to here as a character memory and which typically also includes data pertaining to the identity of the character and/or other permanent data. As will be seen in further detail below, in a preferred embodiment, the character memory is made part of a character item 12 (shown in FIG. 4) such as a character card or figurine which is securely attachable/connectable to the controller for the duration of play with the given character as this can allow to automatically ‘synchronize’ the character memory after each play experience (as opposed to manually synchronizing the character memory by scanning or the like after each game session, for instance). In alternate embodiments, the character memory can even be permanently integrated into the controller 10, for instance. In cases where the character memory is removable or where the character associated to the controller is otherwise interchangeable, the memory can also be used to trigger the association of the corresponding player character to the controller.

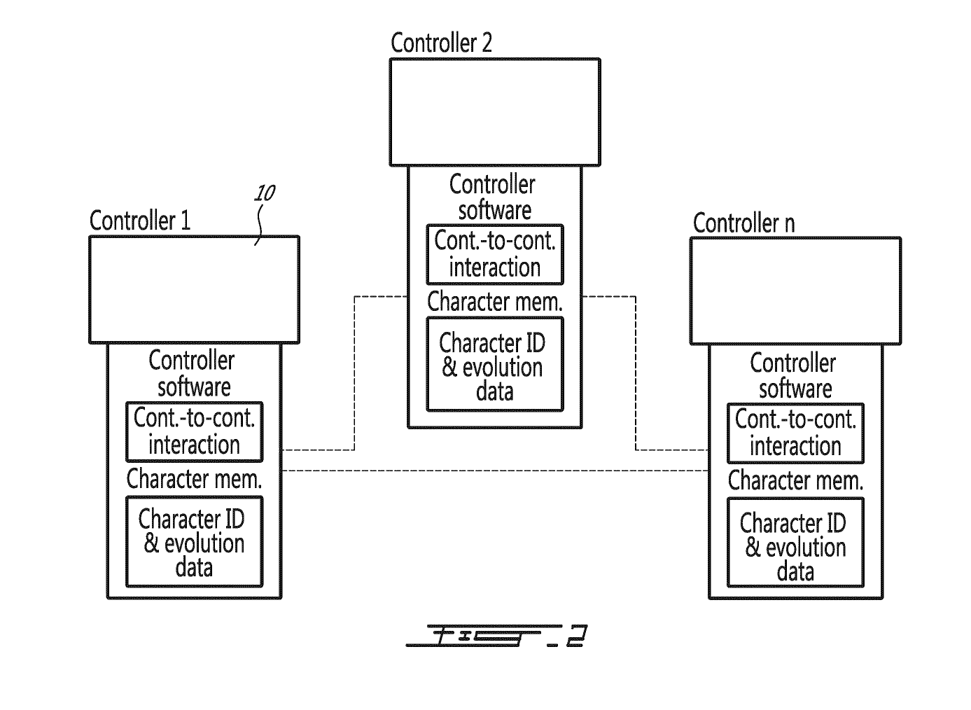

The controllers can be used in an controller-to-controller interaction mode such as shown in FIG. 2, independently of the virtual game software. To this end, each one of the controllers has an independent power source (e.g. a battery port 14 to receive batteries, as seen in FIG. 4), a processor/computer, a communicator subsystem, and a controller software. In this embodiment, for instance, the communicator has an interaction communication module adapted to communicate wirelessly both with the virtual interaction computer and with the other controllers in its vicinity.

The controller software typically includes code allowing to generally operate the controller 10, and also includes a game with data having a given set of rules by which the controller-to-controller interaction can be conducted, and as to how evolution can result from the controller-to-controller interaction. The user controls the controller-to-controller interaction using the interface sensor system of the controller 10, which preferably further includes an accelerometer sensor to favour physical movement of the users in the controller-to-controller interaction and/or the virtual interaction. The controllers preferably also include an indicator system which can include a speaker, vibratory indicator and/or a display screen for instance, and which can be used to communicate information concerning the controller-to-controller game to the user, especially in cases where the physical movements of the other players are not sufficient to enable the game to proceed in a satisfactory manner.

In one embodiment, the character memory is integrated in a character item 12, such as a figurine or card for instance, which can have a connector selectively engageable with or disengageable from a corresponding port 16 of the controller 10. In this manner, the changes pertaining to the character can be completely associated to the character item 12 independently of whether they stem from the virtual interaction or from the controller-to-controller interaction, and the character item 12 can be readily used with any one of the controllers, which can allow selling controllers and character items separately, for instance.

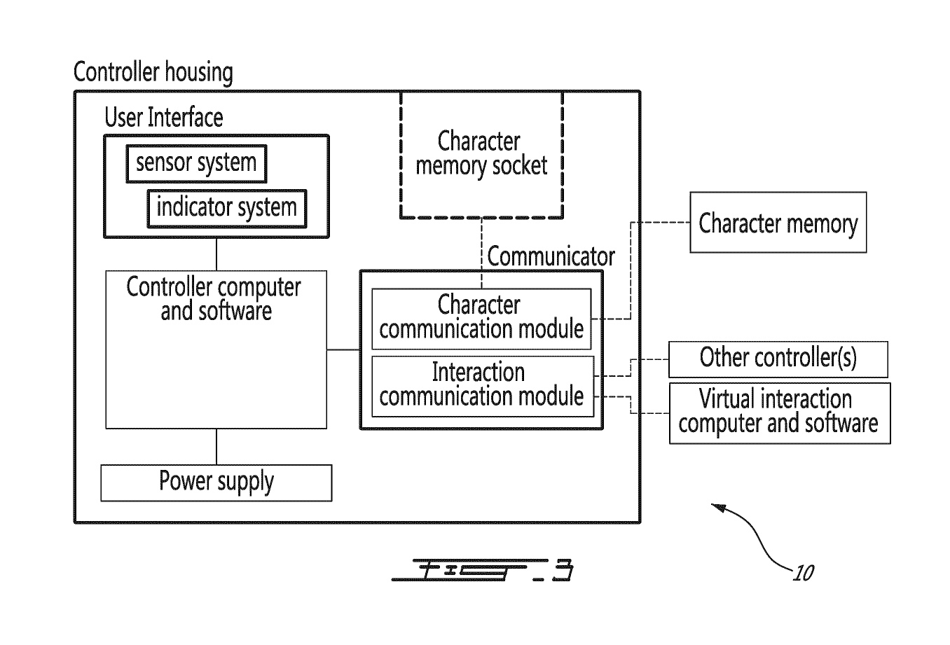

FIG. 3 shows a block diagram of an example controller 10. The portion of the controller 10 which communicates with the character memory is referred to herein as the character communication module, for the sake of convenience. Accordingly, the character communication can be a wireless communicator which can communicate with an external character memory, such as by RFID means or the like, for instance, or simply a portion of hardware and/or software which allows the controller computer to communicate with a character item to be received in a character memory socket of the controller, or even a permanent memory of the controller, to name a few examples. The character communication module can coincide with or use shared components with the interaction communication module if considered appropriate given the specific embodiment.

### Example

The player characters can be robots associated to a futuristic universe. The virtual game software can include a complete storyline explaining the context of the player characters and provide them with challenges leading to a final boss battle, for instance. The player characters can be selected within of a given set of character types, each having specific strengths and weaknesses, and a particular evolution path which can include increases in the player character statistics (e.g. hit points, attack value, defence value, etc.) and learning of special powers or techniques, for instance. A given one of the player characters can progress (change) along its evolution path by successfully defeating foes in the virtual world. Moreover, defeating foes can allow the player characters to gain resources or equipment which can affect the player character statistics, or special techniques, for instance.

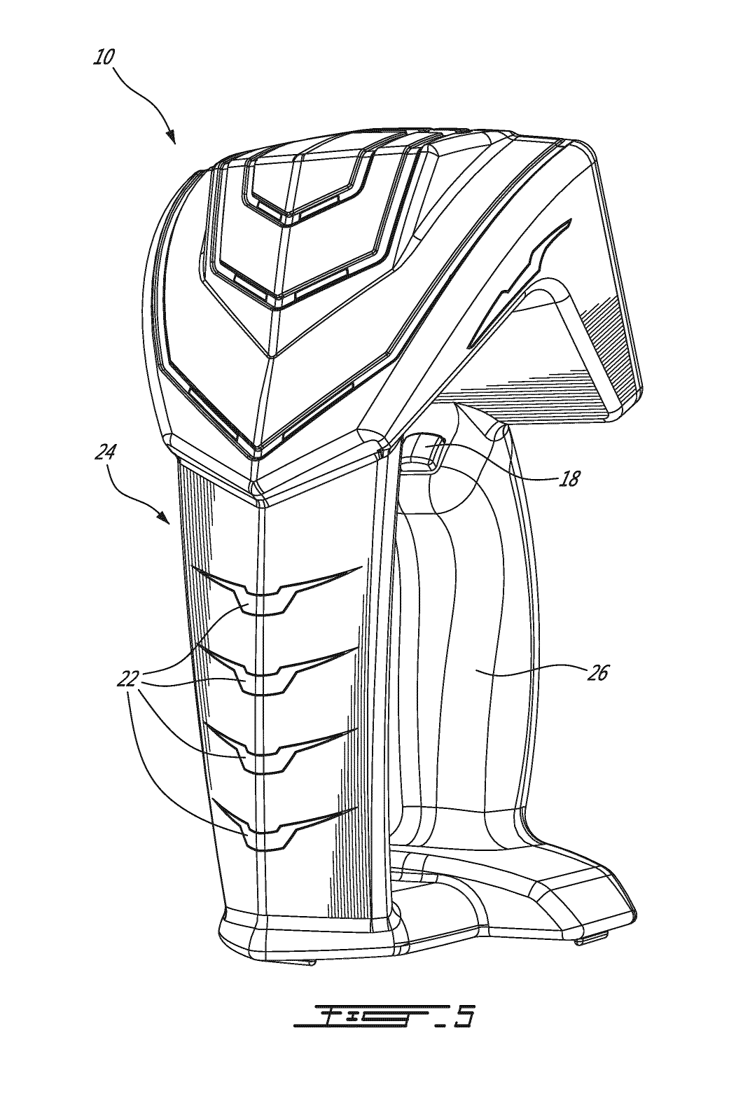

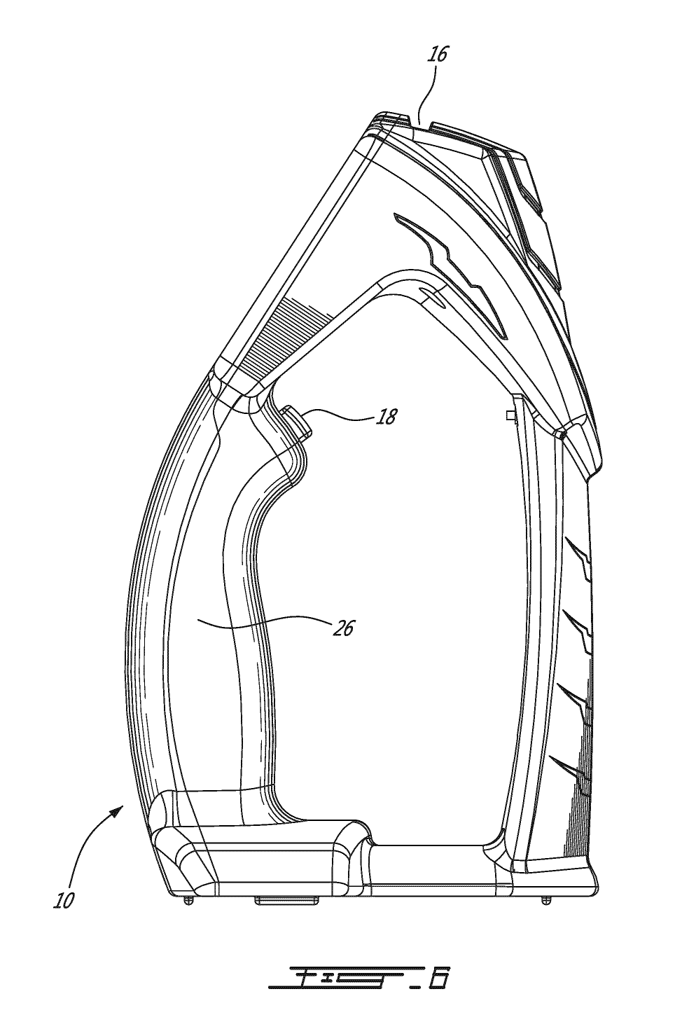

The character item 12 is provided in the form of a card having a RFID chip incorporated therein and a connector. The card 12 can be received in a corresponding port 16 (provided in this case in the form of a connector slot) in the controller 10, such as shown in FIGS. 4 and 6. The controller 10 can allow communicating with both other controllers and a computer hosting the virtual game software. This is done using an integrated wireless communicator functioning at the frequency of 2.4 Ghz in this example. The controller 10 also includes an RFID module which allows to read and write numerical data onto the connected character card 12, and the interface sensor system includes an integrated 9-axis accelerometer sensor, an analog joystick and a pushbutton 18, as shown in FIG. 5.

In this example, non-character cards are also provided. The types of cards are character cards, resource cards, and fragment cards, and can all be referred to as memory items although typically, only the memory of the character cards will be computer-writable. The software allows the controller 10 to become associated with one or more non-character cards in addition to the character card 12, depending on a number of slots the specific character has, which can be achieved by ‘scanning’ these cards using the controller 10. The resource cards and fragment cards can be provided with read only memory (which can make them less expensive to produce). The resource cards can be used to associate a given type of resource to the character, while the fragment cards can be used to provide a performance bonus to the character. In this example, the resource cards can be regularly used by scanning them (connecting them), but remain inactive for a given period of time after activation. It is contemplated to reduce the amount of available resources from scanning any given resource card as time passes, or after a certain timespan has elapsed.

In this example, a random or partially set of cards can be sold in packs and the cards can have a given rarity, as it is known in the field of cards. In one embodiment, the cards can be used to play a card game with, in addition to being used in conjunction with the controllers.

Moreover, the virtual game software can have an online game, and the controller 10 can have a communicator port allowing to connect the controller to the online game via a portable device or other form of computer via USB connection, wireless connection, or the like. In this example, each controller has an electronic key provided in the form of a dongle which is engageable with a USB port. The dongle can be provided upon the sale of the controller and provide for detection of another controller in the vicinity, data synchronization and start-up of the online game.

During the game, four main steps of play can be said to repeat themselves. These are training, collection, improvement, and confrontation. Each of these steps can call for different skills of the player.

The controller-to-controller interaction between two or more duellists is triggered upon detection of another controller in the vicinity, when each controller 10 has a player character card 12 inserted therein. As seen in FIG. 4, a display 20 of the controller 10, which can be a LCD screen for instance, can provide visual information concerning the controller-to-controller interaction to the player. In this example, the controller-to-controller interaction is based on the detection of actions of the player via the interface sensor system. In this specific example, the game in the controller software also includes an action gauge which fill up progressively during play. The attack power increases as the action gauge fills up. The player character has a given amount of hit points which are reduced upon receiving an attack from the enemy. Each player character can be associated to a given one of three elements, for instance, each of which has a strength relative to one of the two other elements and a weakness relative to the other one of the two other elements. When more than one other controllers are in vicinity, the interface sensor system can be activated to change target. The targeted character's hit points and the balance of the elements can also be displayed on the display.

In this specific embodiment, the controller 10 has a plurality of LED lights 22 forming an illuminable bar 24 on the front of the controller 10, opposite the handle portion 26. These LED lights 22 can be used to display health information pertaining to the associated character, for instance, or other information pertaining to game control, in a manner allowing the users of the other controllers to see it and potentially react to it.

In this example, the player can attack by making a large amplitude movement detected by the accelerometer sensor. Upon attacking, the player's action gauge is returned to zero. The player can defend his character by pressing on the push-button (or trigger) 18, allowing to reduce the amount of damage (lost hit points) when attacked. However, while defending, the action gauge fills up much more slowly. The player can also recharge by shaking the controller 10 energetically, or repeatedly activating the trigger 18, for instance, to increase the speed at which the action gauge fills up. However, if hit while recharging, he will take more damage. When the hit points reach zero, the player character is game over. The last remaining player wins. After a duel, the hit points recover gradually. The character card 12 can be changed, or a special fragment card can be read in order to allow beginning a new duel earlier.

In alternate embodiments, more complex movements can be detected with the accelerometer(s) such as up, down, left and right swings, the four diagonal swings, or sequences of movements for instance. Other play features are possible such as using a vibration signal to determine a suitable moment to perform the movement, or requiring to align features on the display to allow a more powerful attack, to name examples.

In this example, the player characters always benefit from controller-to-controller interaction. In addition to improving their technique, the player character can gain glory points, which allow the player to progress in the hierarchy of his clan, money, and resources.

Resources are also gained from cards. The generation of resources can be done over time while a given card is received in a corresponding card slot of the controller 10, based on an internal clock of the controller 10, for instance. The controller 10 can include a memory which store the inventory of the player's resources. Resource cards can be used not only by the player who purchased them, but also by other players which can receive a smaller quantity of resources from them for instance, to favour cooperation amongst a community of players.

Player characters can also be created as part of the virtual game software. For instance, player character robots can include a plurality of components which can be independently produced using game money (credits) and resources, and/or via a mini-game, for instance. A given robot can have portions changed or improved, for instance, for improved statistics, and the changes can be stored in the character card 12.

In the virtual world, during virtual interaction, fights with foes can be effected using a same fighting mechanic than with the controller-to-controller interaction (i.e. use the same action system), or entirely different fighting controls can be provided. Fighting the virtual foes also allows the player to gain credits and resources which can be used to improve the player characters.

The examples described above and illustrated are intended to be exemplary only. The scope is indicated by the appended claims.

1. A hybrid game system controller for use with a character memory containing character data being associated to a character, the hybrid game system controller comprising:
a housing;
a controller computer having a controller software for operating the controller and managing a controller-to-controller interaction mode of the hybrid game, the controller-to-control interaction mode allowing interaction of the associated character with at least one other character associated to an other controller;
an interaction communication module operable to exchange data between the controller and both
i) the at least one corresponding other controller during said controller-to-controller interaction; and
ii) a virtual-interaction computer having a virtual game software managing a virtual interaction mode of the hybrid game, the virtual interaction mode allowing interaction of the associated character with a virtual world represented on a distal display screen;
a sensor system operable manually by a user to control both the virtual interaction and the controller-to-controller interaction; and
a battery port.

2. The hybrid game system controller of claim 1, further comprising a character communication module being operable to exchange data with the character memory; wherein the character memory has at least a computer-writable portion being modifiable to reflect an evolution of the character in the hybrid game; wherein at least one of the controller-to-controller interaction mode and the virtual interaction mode involves evolution of the character reflected on computer-writable portion of the character memory, and wherein the evolution of the character in one of said modes is reflected in the other one of said modes via the character memory.

3. The hybrid game system controller of claim 2 in combination with the character memory, wherein the character memory is inside the housing.

4. The hybrid game system controller of claim 2 wherein the character memory is housed inside a character item, wherein the character item is one of a plurality of character items associated to respective characters.

5. The hybrid game system controller of claim 4 further comprising at least one socket adapted to selectively receive and hold the character item in a manner and to allow removal of the character item to interchange the character item with an other character item associated to an other character and thereby de-associate the former character from the controller and associate the other character to the controller.

6. The hybrid game system controller of claim 1 in combination with at least one non-character item each having an item memory being readable by the controller and affecting at least one characteristic concerning the character.

7. The hybrid game system controller of claim 1, further comprising an indicator system responsive at least to the controller-to-controller interaction; wherein the sensor system includes at least an accelerometer sensor.

8. The hybrid game system controller of claim 2 wherein the character communication module is wireless.

9. The hybrid game system controller of claim 1 wherein the interaction communication module has a wireless data exchanger usable both in the controller-to-controller interaction mode and in the virtual interaction mode.

10. The hybrid game system controller of claim 1 wherein the indicator system includes a visual indicator system opposite the handle portion and facing away from the user.

11. The hybrid game system controller of claim 9 wherein the controller computer displays status data of the associated character in the visual indicator system during said controller-to-controller interaction mode.

12. A method of playing a hybrid game using a controller, a character memory containing character data being associated to a character, and a virtual-interaction computer, the method comprising:
a first user controlling the associated character in a controller-to-controller interaction mode using the controller wherein the associated character interacts with at least one character associated to a corresponding other controller controlled by an other, corresponding, user; and
the first user controlling the associated character in a virtual interaction mode using the controller wherein the associated character interacts with a virtual world managed by the virtual interaction computer and represented on a distal display screen associated to the virtual interaction computer.

13. The method of claim 2, wherein at least one of said controller-to-controller interaction mode and said virtual interaction mode includes evolving the character, storing evolution data associated to said evolution of the character in the character memory, and using the stored evolution data in the other one of said modes.

14. A hybrid game system comprising:
a virtual game software allowing virtual interaction of a plurality of characters with a virtual world in a manner leading to changes relating to said characters, the virtual game software being playable on a computer device operable to display the virtual interaction on a display screen;
a plurality of controllers, each controller having
a communicator;
an access to a character memory adapted to store data concerning the changes relating to at least a character associated to the controller;
a controller software allowing controller-to-controller interaction of the associated character directly with at least one character associated to another one of the controllers via direct communication between said controllers, the controller-to-controller interaction also leading to changes relating to said associated character;
an interface sensor system allowing a user to control both the virtual interaction and the controller-to-controller interaction of the associated character via the communicator;
an indicator system operable based on at least the controller-to-controller interaction.

15. The hybrid game system of claim 14 further comprising a plurality of character items each having an item memory forming a removable portion of the memory of the controller, the item memory being computer readable and a connector, and corresponding to a specific one of the characters, wherein the controllers each further comprises at least one port adapted to selectively receive the connector of the character item to associate the corresponding one of the characters.

16. The hybrid game system of claim 15 wherein the item memory is computer-writable; and the access has the at least one port.

17. The hybrid game system of claim 15 further comprising a plurality of non-character items each having an item memory being computer readable and a connector engageable with the at least one port.

18. The hybrid game system of claim 14 wherein the interface sensor system includes push buttons and an accelerometer sensor.

19. The hybrid game system of claim 14 wherein the indicator system includes a display.

20. The hybrid game system of claim 19 wherein the indicator system further includes a speaker and a vibratory indicator.

21. A method of playing a game in controller-to-controller interaction mode using a controller, the method comprising:
a first user controlling the associated character in a controller-to-controller interaction mode using the controller wherein the associated character interacts with at least one character associated to a corresponding other controller controlled by an other, corresponding, user, including activating an indicator system of the controller based on information pertaining to at least one of the controller-to-controller interaction and a status of the associated character, and thereby signalling said information to said at least one other user.

22. The method of claim 21 wherein said activating an indicator system includes illuminating a plurality of LED lights facing said at least one other user in accordance with a status of the associated character.
